(19) United States
(12) Patent Application Publication
(10) Pub. No.: US 2006/0200756 A1
(43) Pub. Date: Sep. 7, 2006

(54) Publishing system including front-end client links to workflow engine and communication protocol schema

(75) Inventors: Andrea Politi, Milano (IT); Massimiliano Negro, Naples (IT)

Correspondence Address: UNISYS CORPORATION, UNISYS WAY, MAILSTOP E8-114, BLUE BELL, PA, 19424-0001, US

(73) Assignee: Unisys Corporation, Blue Bell, PA (US)

(21) Appl. No.: 10/550,975

(22) PCT Filed: Mar. 18, 2004
(86) PCT No.: PCT/US04/08681

§ 371 Date: Jan. 12, 2006

Related U.S. Application Data
(60) Provisional application No. 60/457,277, filed on Mar. 25, 2003.

(51) Int. Cl. G06F 15/00

(52) U.S. Cl. 715/513

(57) ABSTRACT

A middleware system is provided for use in combination with a publishing system. The publishing system will include a repository and server facilitating editorial services with respect to digital items. These items may be produced by a plurality of front-end clients, and the middleware system includes a software-based mechanism to create an envelope (e.g., a SOAP/XML envelope) associated with each item and to thereby provide an object corresponding to each item. Each object is thereby made accessible to the front-end clients within the publishing system.

### CROSS REFERENCE

The present application claims priority to U.S. Provisional Application No. 60/457,277, filed Mar. 25, 2003, “Front-end (Client) Links to Workflow Engine+Permissions Schema,” which is hereby incorporated by reference in its entirety.

### COPYRIGHT NOTICE

A portion of the disclosure of this patent document may contain material that is subject to copyright protection. The copyright owner has no objection to the facsimile reproduction by anyone of the patent document or the patent disclosure, as it appears in the United States Patent and Trademark Office patent files or records, but otherwise reserves all copyright rights whatsoever. The following notice shall apply to this document: Copyright© 2003, Unisys Corporation.

### FIELD OF THE INVENTION

The present invention relates to the fields of publishing systems and middleware that provides a connection between clients and services on a server, and is particularly adapted to allowing front-end clients to interact efficiently with the server services to integrate and create final publishable documents using various client-based formats in a seamless environment.

### BACKGROUND OF THE INVENTION

A principle application of the present invention is in the field of publishing software. The publishing field is one in which the assignee of the present invention (Unisys Corporation) has been active for a number of years, producing and selling a system called “Hermes” that supports the management, use, integration, formatting and the like, of various items useful for publishing newspapers, magazines and the like, particularly text, pages, images, and charts. Due to the rise of small scale systems and particularly ones that use various other versions of software for working on some or all of these items, e.g., Adobe's “InDesign” and “InCopy” as well as Quark Xpress (sometimes referred to herein as “front-end clients”; see http://www.adobe.com/products/incopy/main.html and http://www.adobe.com/products/indesign/main.html for further information about the Adobe products), many users are familiar and comfortable with using features of these programs for managing their use of these items and preparing and integrating them for publication. Therefore, even though the Hermes system has fine proprietary editors for handling such items, there has developed a need to accommodate such users in a way that permits them to be integrated into the proprietary publishing system. With such integrations the usefulness of legacy systems as well as the added value of user-selected front-end client systems can be maintained in a synergistic manner.

The Hermes system provides a repository and application software for manipulating, managing, sizing, layout, printing, and other related activities with respect to the items (charts, text, images, pages and the like), as do other proprietary publishing systems. Accordingly, a system and method for accomplishing such management and manipulation functions that accepts items formatted in a customer preferred front-end client is desirable. Further, with the rise of open standards such as HTTP, XML, and SOAP, many of the characteristics of the data files for objects can be communicated between and among software components and computing systems. However, there is a need for a system to make this all work together in a commercially viable manner.

### SUMMARY OF THE INVENTION

In accordance with the present invention, a publishing system is provided with a middleware system for enabling manipulation of documents and the like that may be created in front-end clients so as to enable the publishing system to also integrate such manipulated documents and the like into a finished publishing product. The publishing system will include a repository and server facilitating editorial services with respect to digital items. These items may be produced by a plurality of front-end clients, and the middleware system includes a software-based mechanism to handle XML-based messages that can be transmitted as simple remote calls to a server or together with an item, where the item can be a file describing a page or an object in the native client format. Each said object is referenced in the server repository thereby making the item accessible within the publishing system so that the publishing system can track the object, manage the permissions to access it permitting, for example, different users to work with the item), and/or output the item alone or in conjunction with items produced by clients onto specific printers used in the editorial environment.

The present invention provides a system (and method) wherein a middleware system is coupled to a publishing system that includes a repository and server means facilitating editorial services with respect to digital items produced by a plurality of front-end clients. The middleware system comprises a software-based mechanism to create an envelope associated with each item and to thereby provide an object corresponding to each item. Each said object is accessible within the publishing system. In presently preferred embodiments of the invention, the envelope for each item is sufficient to enable the publishing system to manipulate the item. For example, the envelope may be described in SOAP and XML to define and enable handling of the object, and HTTP may be used for transmission of the object. Each item may be characterized by a native format, and the system may include a mechanism to associate additional metadata with each item to identify the native format of the item. Further, the system may be operable as a web service, generating a format field and providing standardized (HTTP/XML/SOAP) connections between the publishing system and the front-end clients. The items produced by the front-end clients may include charts, text, images, and the like. The front-end clients may comprise a writing and editing program and/or a page design program. The editorial services provided by the publishing system may include item manipulation, management, sizing, layout, and printing. The present invention may also be embodied in the form of software on a computer readable medium.

Other aspects of the present invention are described below.

### BRIEF DESCRIPTION OF THE DRAWINGS

FIG. 1 is a flow diagram schematically depicting an exemplary implementation of the invention.

FIG. 2 is a block diagram schematically depicting another exemplary implementation of the invention.

FIG. 3 is a workflow diagram illustrating how the present invention can be used to support copy-driven workflow scenarios.

### DETAILED DESCRIPTION OF ILLUSTRATIVE EMBODIMENTS

We will now describe illustrative embodiments of the present invention. First, an overview of presently preferred embodiments is provided, and this is followed by an overview of web services, XML and SOAP, which are known technologies utilized in connection with the preferred embodiments. These overview sections are followed by a detailed discussion of a preferred implementation of a middleware system and method in accordance with the present invention.

Overview

As discussed above, in one exemplary embodiment of the present invention, a middleware system is provided for use in combination with a publishing system. The publishing system (e.g., the Hermes or similar system) typically will include a repository and server for providing editorial services with respect to digital items produced by front-end clients. The clients can communicate with the publishing system server by sending XML-based messages that can be transmitted as simple remote calls, or as messages combined/associated with an item, where the item can be a file describing a page or an object in the native client format. An envelope for each item is preferably sufficient to enable the publishing system to manipulate the item. In an exemplary implementation of the invention, the envelope is described in SOAP and XML to define and enable handling of the object, and HTTP is used for its transmission. Moreover, each item is typically characterized by a native format, and a middleware system is employed and preferably includes a mechanism to associate additional metadata with each item to identify the native format of the item. The system is therefore operable as a web service, generating a format field and providing standardized (HTTP/XML/SOAP) connections between the publishing system and the front-end clients. Most preferably, the system will also include a software-based mechanism for providing items from the publishing system to the front-end clients in a native format of the front-end clients.

Thus, the present invention permits a first, proprietary or other large-system publishing system (Hermes, for example) to manage and manipulate as objects the items created by third party (such as front-end client) applications. To achieve this, a set of metadata about these items is produced. For example, in an illustrative implementation of the invention, the native page/object/image file is managed by the editorial system in the sense that the system tracks its status, access permissions and workflow, although the content of the asset is editable only by the client application that generated it (this is because the generating client has the knowledge of specific page/object elements, such as specific decorated fonts, shapes, layout composition, etc.). The metadata envelope identifies a set of characteristics about the item and allows the item to be managed by the proprietary system. Further, the front end or client software through which the item was created is not affected, because we provide the data file of the item in an unmodified format back to the client software, which is advantageous, e.g., should further content manipulation be needed either to support integration into the final document for publishing or for other reasons. To accomplish this a metadata envelope is created around the item to make it into an object that is manageable by the server.

Accordingly, for example, using software to connect to clients InDesign and InCopy (such software may include InDesign/InCopy-compatible workflow software such as, e.g., Woodwing SmartConnection Pro; see http://www.woodwing.nl/smartconnect.htm), a SOAP connector is used to forward the partially packaged object to the workflow engine and permissions schema (e.g., the Hermes editorial system), which then decouples each file and the SOAP request in different elements, so that they are manageable, and keeps track of what happens to the object inside of its repository. Thus, this middleware operates like a web service, providing HTTP/XML/SOAP connections between the workflow engine and permissions schema and the client software.

It should be noted that the SmartConnection software may also be used to connect an InCopy object to InDesign pages at the file system level, without involving the Hermes system. The SmartConnection software “as-is” (typical configuration) is a product that enables connectivity between InCopy and InDesign. This is useful because there is no support in the native InDesign for linking InCopy files to InDesign pages. SmartConnection enables connectivity also with the ability of doing a check-in/out of InCopy texts from InDesign pages. This occurs only on the client without integration with the editorial system. The mechanism of linking InCopy and InDesign at a file level (i.e., everything occurs on the client with no way to manage a workflow) has been extended to provide that linking with the workflow management supplied by Hermes. Per se, the SmartConnection software offers only the handling of files and a user interface (GUI, or palette inside InDesign) to display data. In our case, the data are query results performed via SOAP against the Hermes database, for example. The login function for connecting InDesign/InCopy to the editorial system via SOAP is done by our Hermes Connector, that is, a plugin for InDesign/InCopy. In the editorial environment, connections between objects and pages is managed by the database. The InDesign/InCopy clients may use that information to reestablish the connections when a page, for example, is open from the Hermes system. In essence, SmartConnection is something that manages the links on the client but those links are kept and managed by the server. SmartConnection is an implementation that allows the connection on the client but it is not the only one.

The term “middleware” as used herein is intended to be accorded a broad definition, and its use is not intended to limit the scope of protection of the claims set forth at the end of this specification. In general, “middleware” encompasses software that connects two otherwise separate applications. It is known, however, that such “middleware” could in some cases be more effectively integrated into one of the applications, e.g., it could be implemented as an import or export feature of one of the applications. Unless explicitly stated otherwise in the claims, use of the term “middleware” is not intended to limit the present invention to scenarios wherein the middleware layer is kept separate from one or the other applications. For example, the present invention may be practiced by making the middleware layer a part of the publishing system server.

In a similar vein, it should be noted that the invention is sometimes described herein with reference to a “web service”. The term “web service” is intended to be construed broadly to encompass a software system, which may be identifiable by a uniform resource identifier (URI), whose public interfaces and bindings are defined and described using XML. In this manner, the web service definition can be discovered by other software systems, which may then interact with the web service in a manner prescribed by its definition, using XML based messages conveyed by Internet protocols. As data communications technology progresses, we believe adaptations thereto shall be available without undue experimentation to those of ordinary skill in these arts.

Web Services, XML & SOAP, and Their Application to the Invention

To provide a more thorough explanation of the technologies underlying the presently preferred implementations of the subject invention, we will now provide an overview of web services, XML and the Simple Object Access Protocol (SOAP). We note, however, that persons of ordinary skill in the field of the present invention will no doubt be very familiar with these technologies.

Standalone applications and Web sites create islands of functionality and data. Users may be forced to navigate manually between Web sites, devices, and applications, logging in each time, rarely being able to carry data from one site to another. This makes business tasks that ought to be simple very difficult and many times repetitive.

As a result of the changes in how businesses and consumers use the Web, industry, particularly the publishing industry, is converging on a new computing model that enables a standard way of building applications and processes to connect and exchange information over the Web. This new Internet-based integration methodology, called “XML Web services,” enables applications, machines, and business processes to work together. Web services describe themselves to the outside world; telling the world what functions they perform, how they can be accessed, and what kinds of data they require. The widespread support around XML makes it likely that businesses will cooperate in the Internet-based economy with this XML Web services model.

XML Web services utilize XML (extensible Markup Language) to develop formats for describing data components. XML is an open industry standard managed by the World Wide Web Consortium. It enables developers to describe data being exchanged between PCs, smart devices, applications, and Web sites, etc. Because the data is separate from the format and style definitions, it can be easily organized, programmed, edited, and exchanged between Web sites, applications, and devices. XML has transformed how applications talk to each other, enabling more and more businesses to exchange data and process documents electronically without requiring piecemeal creation of both client and server-side interactive components and services. Web services are described in XML and are communicated over the existing HTTP infrastructure. Web services can be written and called in almost any language: VC++, C#, VB, Java, and JavaScript.

Overview of SOAP

The transport of XML over HTTP has been codified as the Simple Object Access Protocol (SOAP). SOAP is a lightweight protocol for exchange of information in a decentralized, distributed environment. It is an XML based protocol that includes three parts: an envelope that defines a framework for describing what is in a message and how to process it, a set of encoding rules for expressing instances of application-defined datatypes, and a convention for representing remote procedure calls and responses. Web services can be called with messages that are written in the SOAP format. A well-formed XML fragment enclosed within SOAP elements is a SOAP message. When using SOAP, a client-side component can allow an application to invoke XML Web service operations by using a Web Services Description Language (WSDL) file. Also, a server-side component may map invoked XML Web service operations described by WSDL and a Web Services Meta Language (WSML) file.

The following paragraphs provide a further explanation of how a message can be communicated using SOAP. For further technical information about the SOAP, see http://www.w3schools.com/soap/default.asp.

As discussed, it is generally important to allow Internet communication between programs. Many modern application programs communicate using Remote Procedure Calls (RPC) between objects like DCOM and CORBA, but HTTP was not designed for this. RPC represents a compatibility and security problem; firewalls and proxy servers will normally block this kind of traffic. Thus, it has been determined that a better way to communicate between applications is over HTTP because HTTP is supported by Internet browsers and servers. SOAP was created to accomplish this. SOAP provides a way to communicate between applications running on different operating systems, with different technologies and programmning languages.

A SOAP message is an ordinary XML document containing the following elements:
1. a required Envelope element that identifies the XML document as a SOAP message;
2. an optional Header element that contains header information;
3. a required Body element that contains call and response information; and
4. an optional Fault element that provides information about errors that occurred while processing the message.

All the elements above are declared in the default namespace for the SOAP envelope—see http://www.w3.org/2001/12/soap-envelope. For background on the default namespace for SOAP encoding and data types, see http://www.w3.org/2001/12/soap-encoding.

The following table illustrates an exemplary skeleton SOAP message:

<?xml version=“1.0”?>
<soap:Envelope
xmlns:soap=“http://www.w3.org/2001/12/soap-envelope”
soap:encodingStyle=“http://www.w3.org/2001/12/soap-encoding”>
<soap:Header>

. . .
. . .

</soap:Header>
<soap:Body>

. . .
. . .
<soap:Fault>

. . .
. . .

</soap:Fault>

</soap:Body>
</soap:Envelope>

As can be seen, the SOAP envelope element is the root element of a SOAP message. It defines the XML document as a SOAP message. Note the use of the “xmlns:soap” namespace. It should always have the value of: http://www.w3.org/2001/12/soap-envelope, and it defines the envelope as a SOAP envelope:

<?xml version=“1.0”?>
<soap:Envelope
xmlns:soap=“http://www.w3.org/2001/12/soap-envelope”
soap:encodingStyle=“http://www.w3.org/2001/12/soap-encoding”>

. . .
Message information goes here
. . .

</soap:Envelope>

A SOAP message should always have an envelope element associated with the “http://www.w3.org/2001/12/soap-envelope” namespace. If a different namespace is used, the application should generate an error and discard the message. In addition, the SOAP encodingStyle attribute is used to define the data types used in the document. This attribute may appear on any SOAP element, and it will apply to that element's contents and all child elements. A SOAP message has no default encoding. The following table illustrates these rules:

<?xml version=”1.0”?>
<soap:Envelope
xmlns:soap=″http://www.w3.org/2001/12/soap-envelope″
soap:encodingStyle=″http://www.w3.org/2001/12/soap-encoding″>
. . .
Message information goes here
. . .
</soap:Envelope>

The optional SOAP header element contains application specific information (e.g., authentication, payment, etc) about the SOAP message. If present, the header should be the first child element of the envelope element, for example:

<?xml version=“1.0”?>
<Soap:Envelope
xmlns:soap=“http://www.w3.org/2001/12/soap-envelope”
soap:encodingStyle=“http://www.w3.org/2001/12/soap-encoding”>
<soap:Header>
<m:Trans
xmlns:m=“http://www.w3schools.com/transaction/”
soap:mustUnderstand=“1”>234</m:Trans>
</soap:Header>
. . .
. . .
</soap:Envelope>

Each SOAP message is carried as part of an HTTP request/response packet. Together with standard HTTP header values, the protocol to connect a front-end client with the publishing system involves more specific header values to be inserted into each HTTP message:

SOAPAction: this header variable is specified in the SOAP specification and contains a value indicating the endpoint that should fulfill the request. In the exemplary implementation described herein, we have different endpoints:

| Value of SOAPAction | Used in |
|---|---|
| HermesSOAP | All the specific editorial functions, such |
| | as enumerate editions, create a page, |
| | browse publication levels. |
| HermesRegisterListener | Used whenever a client application needs |
| | to be notified by the server, for example, |
| | to receive mail from proprietary post |
| | office software. When a client registers |
| | to the server, there is an inversion of |
| | roles in sense that the client acts also |
| | as a server (listening for incoming SOAP |
| | messages) and the server acts also as a |
| | client (sending SOAP messages). |
| HermesSOAPLogin | Endpoint used to make login/logout |
| | (authentication) operations against the |
| | publishing server. |

The second header value is SESSIONID. The HTTP specification allows one to place any arbitrary header value in the HTTP header. We use the SESSIONID because after a successful login, the publishing system generates a unique identifier that is used by the front-end clients. In this way, the publishing system can identify uniquely the client application making a request.

The above example of an envelope element contains a header with a “Trans” element, a “mustUnderstand” attribute value of “1”, and a value of “234”. SOAP defines three attributes in the default namespace. These attributes are actor, mustUnderstand, and encodingStyle. The attributes defined in the SOAP header defines how a recipient should process the SOAP message. A SOAP message may travel from a sender to a receiver by passing different endpoints along the message path. Not all parts of the SOAP message may be intended for the ultimate endpoint of the SOAP message but, instead, may be intended for one or more of the endpoints on the message path. For example, the SOAP actor attribute may be used to address the header element to a particular endpoint. The SOAP mustUnderstand attribute can be used to indicate whether a header entry is mandatory or optional for the recipient to process.

The SOAP body element contains the actual SOAP message intended for the ultimate endpoint of the message. Immediate child elements of the SOAP body element may be namespace-qualified. SOAP defines one element inside the body element in the default namespace. This is the SOAP fault element, which is used to indicate error messages. The following table illustrates this:

<?xml version=“1.0”?>
<soap:Envelope
xmlns:soap=“http://www.w3.org/2001/12/soap-envelope”
soap:encodingStyle=“http://www.w3.org/2001/12/soap-encoding”>
<soap:Body>

<m:GetPrice xmlns:m=“http://www.w3schools.com/prices”>

<m:Item>Apples</m:Item>

</m:GetPrice>

</soap:Body>
</soap:Envelope>

The example above requests the price of apples. Note that the m:GetPrice and the Item elements above are application-specific elements. They are not a part of the SOAP standard.

With the foregoing overview as background, we will now describe in greater detail the presently preferred implementations of the present invention.

Middleware System and Method

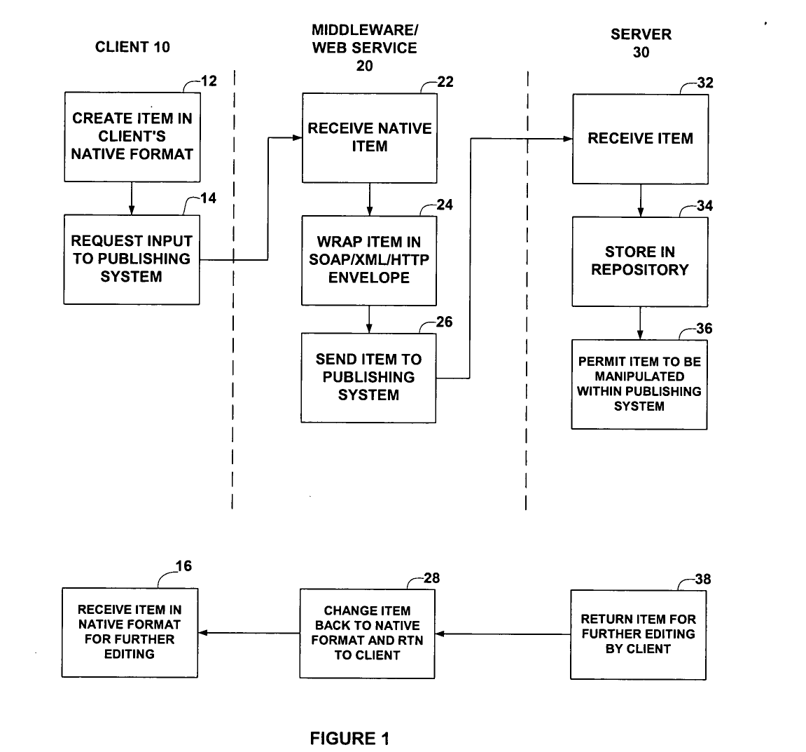

We will now explain the present invention in greater detail with reference to the drawings, particularly, FIGS. 1-3.

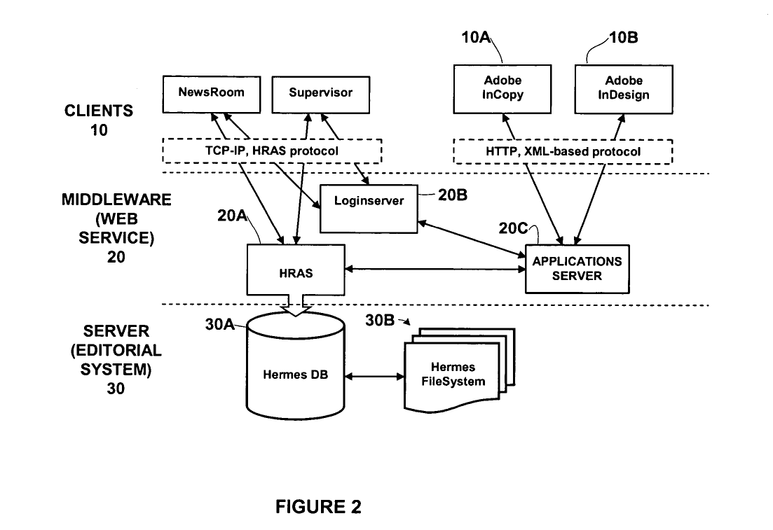

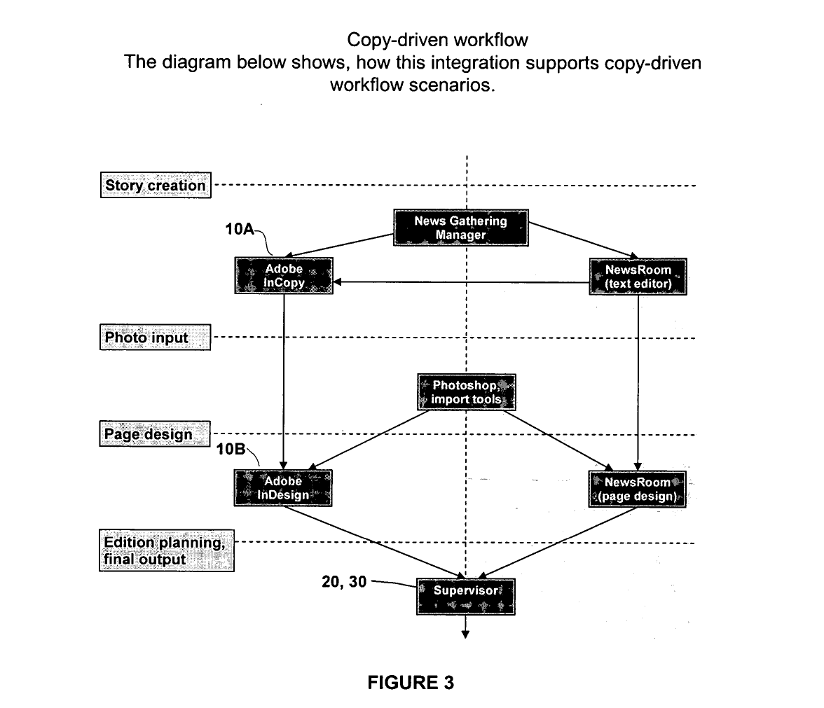

Referring to FIG. 1, in a typical use of the present invention, a client computer 10 is used in a first step 12 to create an item in the client's native format. For example, as discussed above and shown in FIGS. 2 and 3, the client may include the Adobe InCopy and/or InDesign applications, which are identified in FIGS. 2 and 3 with reference numerals 10A and 10B, respectively. The client 10 may then perform a next step 14 in which it requests input of the item to a publishing system. According to the invention, a piece of “middleware”, which could operate as a web service, is employed to carry out this step. This middleware/web service is designated with reference numeral 20 in FIGS. 1-3. In FIG. 2, it is shown as comprising three components, namely, an HRAS 10A, a login server 20B, and a an application server 20C. The application server is used to forward SOAP requests to the SOAP layer for further processing of the methods. These are exemplary, functional components and are not required to practice the present invention. In FIG. 3, the middleware/web service 20 is shown as being integrated with the server component 30, in a box labeled “Supervisor”, thus indicating that it is not strictly necessary that the middleware layer be physically separated from the server layer.

The Supervisor application is a client application that is used to plan the newspaper/magazine. Each newspaper can be viewed as a set of pages aggregated into editions, and each edition can be inherited into other editions so that a page can have the same editorial content in different zones and different advertising content, one for each zone (this relates to content reuse, i.e., where the news is the same in a given country or region but the advertising depends on where it is published). The pages in Supervisor are called “physical pages” because they are printed onto plates that in turn are placed into a press to produce the newspaper pages that a consumer can read. In Hermes, all the pages produced by Newsroom or by the front end clients are called logical pages. Basically, logical pages are where the content is placed (layout of the pages, news, pictures) but they, for example, do not have page numbers until they are imposed with Supervisor onto a physical page. The physical page is then imposed onto a plate, which is the physical medium on which the page is printed and then the plate is placed into the press.

Returning now to FIG. 1, as shown, the middleware/web service 20 performs the step 22 of receiving the native item or a SOAP message without native file from the client 10. Next, it extracts the SOAP requests from the HTTP buffer, parses the SOAP request and dispatches the request to the service that can fulfill that request. If a request is intended to carry also the native file, for example, when the item must be stored into the publishing system, the server extracts the binary data corresponding to the native item (step 24). In this case, when the native item is sent by the front end client, the server saves the item onto the file system and updates the references into the publishing database. From that point, working on that item requires that the user have the right privileges to read, write, or list it. An item can be not only a proprietary file format but also, for example, an image. When an image is placed on a page of the font-end client, it is linked to the page. Due to the characteristic of the professional printing, the image needs to be included in the final output with the highest resolution possible but since the high resolution can be very expensive in size, the transmission can slow down dramatically making it difficult or impossible for the user to work with the image. In this case, the SOAP message to save and link the image results in a series of activities involving the server:
1. The client sends the very high resolution to the server.
2. The server stores the high resolution image and down samples the image to produce a low resolution version of the same image.
3. The server responds to the client that the object (image in this case) has been processed successfully and the low resolution version is carried with the response.

Now the client can use the low resolution version of the same picture to make the user's work easily. When the final output is performed, the PostScript file representing the page contains special tags (OPI, open prepress interface) that instruct the typesetter to substitute the low resolution image sent by the client with the high resolution stored on the server. In this way, the handling of the large image is made by specialized hardware (typesetter).

Referring to FIG. 2, the server is depicted as being associated with the “editorial system” and comprising a Hermes database 30A and a Hermes File System 30B.

Referring again to FIG. 1, the server 30 receives the request with the item (step 32), stores the item in a repository, i.e., database (step 34), and permits the item to be manipulated within the publishing system or server 30 (step 36). Thereafter, the server 30 may return the item for further editing by the client (step 38). In step 16 the client receives the item and may then perform any desired editing.

Refer now to FIG. 2. As shown, the clients 10A and 10B communicate with the middleware/web service 20, e.g., through the application server 20C, by formatting their messages in accordance with the HTTP and XML-based protocols. These well-known protocols are commonly used to communicate with web servers. Although not an aspect of the present invention, it should also be noted that other clients 10, e.g., the Newsroom and Supervisor applications, may communicate with the middleware/web service 20 using a proprietary protocol over TCP/IP. The TCP/IP protocol is a well known, standard low level protocol and, on top of it, there is an application level proprietary protocol used for communication between proprietary application and the editorial system.

It should now be clear that the middleware system performs a bridging function with respect to a variety of client applications. Normally, in a client-server environment, a client application connects to a server application by way of client libraries, which are pieces of code that offer to the client specific APIs to make the connection possible. This is a limited way of communicating between software elements because, for example, the client software needs to have the specific libraries to be able to use server functionality. Moreover, in a typical client-server environment, such as the Hermes system, the client and the server move back and forth the data required for any operation. The SOAP integration platform allows one to “externalize” the proprietary, server side functions and make them available to any client without requiring the client to have a specific library. The middleware does this by interacting natively with the editorial or publishing system on one side, and on the other side provides a client with the ability to call those APIs without knowing anything about them, other than the XML description. Accordingly, there is no need for a client to have specific libraries to access the functionality of the editorial system.

That said, the SOAP API has been designed to abstract implementation details to the client. For example, if a client needs to obtain a list of available editions for use in connection with a newspaper page/object, it can call an XML SOAP method called HermesEnumEditions and wait for a response from the server with the list of editions. The server and the middleware, to fulfill the request, perform the following steps:

1. Read the request from the client.

2. Verify that the request comes from a valid authenticated client (e.g., the client has a valid SESSIONID).

3. Dispatch the call to a service, or piece of software, that actually interacts with the publishing system internally.

4. The service in turn calls some server functions to fetch the list of editions.

5. The middleware offers to the service a set of methods to create a SOAP XML response that is valid and conforming to the SOAP specification.

6. Prepare the HTTP buffer to be sent to the client. The buffer encapsulates the SOAP response.

7. Send back to the client the HTTP buffer with the response.

This is a simple example of interaction without involving any page or object (i.e., item). If we look at the overall process to save a page/object into the publishing system, the front end application calls several APIs:

1. HermesEnumLevels, to obtain the level tree. You can think about a level like a folder on a file system, with the difference that the available levels are 5. For example, a sports page could be created into a level called “PUBLICATIONS/EDITORIAL/SPORT”. An article could be saved into “PUBBLICATION/EDITORIAL/SPORT/ARTICLES” and the relevant images “PUBBLICATION/EDITORIAL/SPORT/PAGES/IMAGES”. The names of the levels are decided at configuration time and can vary. To uniquely identify a level, the publishing system uses the unique level identifier.

2. HermesEnumEditions, to obtain the list of editions available for placing the page/object.

3. HermesGetNextValidPubdate, to obtain the next valid publication date. The publication date in a newspaper world can vary, for example there may be no publication on the 1^{st} of January. These dates are kept by the publishing system and, again, the client does not handle the details of navigating the publishing calendar. Something like “give me the next valid date,” and the server says “03-30-2004”. Internally the publishing server could obtain this simple date by calling proprietary methods.

We will now explain further how the present invention may be employed to facilitate a publisher's use of a system such as Hermes in combination with front-end clients such as InDesign and InCopy. Let's say the user is working in a Windows environment (where the Hermes client application exists). The user can take advantage of useful features: From UPSExplorer (the Hermes client tool to query, searching both editorial content and wires), once the asset, page or object, has been identified, the user can select (double click on) the element of the query result to open the originating application, in this example InDesign/InCopy. The front-end client, once opened, can post a SOAP message to the Hermes SOAP server to obtain the page/object.

Now consider a production scenario: Typically, the newspaper/magazine is planned by starting with the advertising. To do this with Hermes, the newspaper/magazine is planned with Supervisor. The newspaper/magazine is “constructed” by creating pages into editions. Those pages exist inside the Hermes database as “simple” data, since for the native Hermes environment pages and objects are not stored as files. A problem arises, however, since external applications (InDesign and InCopy) require a file to handle the content. What we have done is to provide the external application with enough information to create a page/object in the native format. That information is provided as a SOAP XML message. Continuing with the production scenario, once the pages have been created with Supervisor, the user can choose “open page” to begin design of the layout. In this case, InDesign is triggered to a specific API implemented inside it and that Supervisor knows, that tells it: “Open yourself if needed and ask Hermes via SOAP to open a page called <whatever> that exists in the edition <whatever>, etc.”The SOAP server will provide a SOAP response with enough information to let InDesign create a page and write the file in its native format. From that point, the file will be used whenever the page is to be open/saved.

We now turn our attention to a further discussion of an exemplary XML schema for use in connection with the present invention.

XML Schema

A schema may be used to define a class of XML documents. The term “instance document” is often used to describe an XML document that conforms to a particular schema however, neither instances nor schemas need to exist as documents per se—they may exist as streams of bytes sent between applications, as fields in a database record, etc.). A schema can be viewed as a collection of type definitions and element declarations whose names belong to a particular target namespace. Target namespaces enable one to distinguish between definitions and declarations from different schemas.

An exemplary schema description is provided below in the Appendix set forth before the claims. This exemplary schema description includes the following namespace references:

<xs:schema targetNamespace=“http://www.unisys.com”
elementFormDefault=“qualified”
xmlns:xs=“http://www.w3.org/2001/XMLSchema”
xmlns=“http://www.unisys.com” xmlns:mstns=“http://www.unisys.com”
xmlns:msdata=“urn:schemas-microsoft-com:xml-msdata”>
<xs:include schemaLocation=“DataTypes.xsd”/>

As can be seen, the schema can include definitions for elements corresponding to messages and functions that may be performed in connection with the exemplary Hermes publishing (editorial) system. A schema file acts as a contract between the Integration Platform for the publishing system and the front-end clients. The schema defines the data types and the methods that can be used by both to communicate over HTTP. In this way, there is a complete independence between the client and the server implementation, platform and physical location These elements, both data types and SOAP APIs in the preferred embodiment include but are not limited to the following: HermesLogin, HermesLoginResponse, HermesLogout, HermesLogoutResponse, HermesError, Level, HermesEnumLevels, HermesEnumLevelResponse, HermesGetLevelData, HermesGetLevelDataResponse, Edition, HermesEnumEditions, HermesEnumEditionsResponse, HermesEnumGrids, HermesEnumGridsResponse, HermesLoadGridData, HermesLoadGridDataResponse, User, HermesGetUserData, HermesGetUserDataResponse, HermesEnumUsers, HermesEnumUsersResponse, Status, HermesGetInitialStatus, HermesGetInitialStatusResponse, HermesGetStatusData, HermesGetStatusDataResponse, HermesGetNextValidStatus, HermesGetNextValidStatusResponse, HermesGetNextValidStatus, HermesGetAllValidStatus, HermesGetAllValidStatusResponse, HermesGetAllStatus, HermesGetAllStatusResponse, HermesGetObjectStatus, HermesGetObjectStatusResponse, ObjectIdentification, QueryUserDataAccess, UserDataAccess, Object, HermesUnLockObject, HermesUnLockObjectResponse, HermesLockObject, HermesLockObjectResponse, HermesIsObjectLocked, HermesGetModificationData, HermesQueryObject, HermesEnumObjectTypes, HermesEnumObjectTypesResponse, HermesGetNextValidPubDate, HermesSendAlert, HermesSendMail, EventTypeList, MetadataField. We will not explain these elements or describe the exemplary schema in greater detail, since persons having an ordinary level of skill in XML programming will be able to understand the schema description set forth in detail in the appendix.

Related Documents

The following documents were cited and incorporated by reference in the above-cited Provisional Application Ser. No. 60/457,277.
1. Software License and Development Agreement Number 02/00311346 by and Between Unisys Corporation and Woodwing Software bv. This document describes an overall architecture and design specification for integration between Woodwing's SmartConnection Pro software and the Hermes SOAP Connector/Services middleware.
2. Database Format Field Design Specification. This document identifies format field characteristics that may be employed in practicing the invention.
3. Hermes Connector Use Case Specification. This document describes illustrative use cases.
4. SOAP Application Server Project Design Specification. This document describes an exemplary SOAP application server design.
5. SOAP Integration Platform Project Design Specification. This document describes an exemplary SOAP integration platform system.
6. Third Parties Integration with NewsRoom Design Specification. This describes an exemplary design for third party integration with NewsRoom, which is a component of Hermes that may have counterparts in other similar workflow and permissions systems.
7. Integration Platform Project Supplementary Specification. This document describes a prototype design of Hermes integration using HTTP and SOAP.
8. Database Format Field Project Functional Specification. This document describes an exemplary database format for use in storing objects/pages from third party native applications so they can be retrieved from the Hermes database (i.e., adding a string field to the pages table of the Hermes database).
9. Adobe® Integration with eEditorial® Solutions Project Design Specification. This document describes an exemplary Hermes Web Services API.
10. A 26 page chart of exemplary iconography.
11. Third Parties Integration with NewsRoom Project Functional Specification. This further describes exemplary ways of integrating third party applications with NewsRoom and makes reference to Third Parties Integration with NewsRoom Design Specification.
12. Workflow Definition for External Objects Project Functional Specification. This document describes aspects of the integration of third party applications with Hermes applications.
13. Adobe InDesign Integration with News Content Manager—Hermes. This document describes scenarios for the integration of Adobe applications with the Hermes system.
14. Advanced Query in Third Party Applications Design Specification. This describes further aspects of the integration of third party applications with the Hermes system.
15. Pages and Objects Management in External Applications Project Functional Specification. This describes aspects of how pages and objects created with third party applications may be managed so as to integrate them with the Hermes workflow.
16. Hermes Palette Availability in External Applications Project Functional Specification. This document describes a tool palette for use by third party applications so as to provide access to content stored in Hermes.
17. Third Parties Integration with Hermes Explorer Project Functional Specification. This document describes aspects of changes to the Hermes Explorer module implied by the integration of third party applications.

Conclusion

While exemplary embodiments of the present invention have been described in connection with certain computing devices and network architectures, the underlying concepts may be applied to any computing device or system in which it is desirable to define interfaces or services between devices or objects across a network. Thus, the techniques described herein for facilitating interoperability between various front-end clients and a server may be applied to a variety of applications and devices. Further, while exemplary programming languages, names and examples are chosen herein as representative of various choices, these languages, names and examples are not intended to be limiting. One of ordinary skill in the art will recognize that such languages, names and examples are choices that may vary depending upon which type system is implicated, and the rules for the system. Although particular names for software components are utilized herein for distinguishing purposes, any name would be suitable and the present invention does not lie in the particular nomenclature.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the histogram of the present invention, e.g., through the use of a data processing API or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

Thus, while the present invention has been described in connection with the preferred embodiments as illustrated, it is to be understood that other similar embodiments may be used or modifications and additions may be made to the described embodiments for performing the same function of the present invention without deviating therefrom. For example, while exemplary embodiments of the invention are described in the context of a loosely coupled client-server network, one skilled in the art will recognize that the present invention is not limited thereto, and that the methods described herein may apply to any computing device or environment, such as a handheld or portable computer, etc., whether wired or wireless, and may be applied to any number of such computing devices connected via a communications network, and interacting across the network. Therefore, the present invention should not be limited to any single embodiment, but rather should be construed in breadth and scope in accordance with the appended claims.

What is claimed:

1. A publishing system including a middleware system, wherein the publishing system includes a repository and server means facilitating editorial services with respect to digital items produced by a plurality of front-end clients, said middleware system comprising a software-based mechanism to create an envelope associated with each item and to thereby provide an object corresponding to each item, each said object being accessible within said publishing system.

2. A system as recited in claim 1, wherein said envelope for each item is sufficient to enable the publishing system to manipulate the item.

3. A system as recited in claim 2, wherein said envelope is described in SOAP and XML to define and enable handling of the object and HTTP is used for its transmission.

4. A system as recited in claim 1, wherein each said item is characterized by a native format, and wherein the system includes a mechanism to associate additional metadata with each said item to identify the native format of the item.

5. A system as recited in claim 1, wherein the system is operable as a web service, generating a format field and providing standardized (HTTP/XML/SOAP) connections between the publishing system and the front-end clients.

6. A system as recited in claim 1, wherein said items produced by the front-end clients include charts, text, and images.

7. A system as recited in claim 1, wherein at least one of said front-end clients comprises a writing and editing program.

8. A system as recited in claim 1, wherein at least one of said front-end clients comprises a page design program.

9. A system as recited in claim 1, wherein said editorial services provided by the publishing system include item manipulation, management, sizing, layout, and printing.

10. A system as recited in claim 1, further comprising software based mechanism for providing items from the publishing system to the front-end clients in a native format of said front-end clients.

11. A system as recited in claim 1, wherein said envelope for each item is described in SOAP and XML to define and enable handling of the object, and HTTP is used for its transmission; and wherein each said item is characterized by a native format, and the system includes a mechanism to associate additional metadata with each said item to identify the native format of the item; and wherein said items produced by the front-end clients include charts, text, and images; and further comprising a software based mechanism for providing items from the publishing system to the front-end clients in the native format of said front-end clients.

12. A method for facilitating the interoperability of a publishing system with a plurality of front-end clients, wherein the publishing system includes a repository and a server for providing editorial services with respect to digital items produced by the front-end clients, wherein each digital said item is characterized by a native format, the method comprising the creation of a metadata envelope associated with each item, thereby providing an object corresponding to each item, each said object being accessible within said publishing system.

13. A method as recited in claim 12, wherein said envelope for each item is sufficient to enable the publishing system to manipulate the item.

14. A method as recited in claim 13, wherein said envelope is described in SOAP and XML to define and enable handling of the object and HTTP is used for its transmission.

15. A method as recited in claim 12, wherein each said item is characterized by a native format, and further comprising the provision of additional metadata to be associated with each said item to identify the native format of the item.

16. A method as recited in claim 12, wherein the method is performed as a web service, generating a format field and providing standardized (HTTP/XML/SOAP) connections between the publishing system and the front-end clients.

17. A method as recited in claim 12, wherein said items produced by the front-end clients include charts, text, and images.

18. A method as recited in claim 12, wherein at least one of said front-end clients comprises a writing and editing program.

19. A method as recited in claim 12, wherein at least one of said front-end clients comprises a page design program.

20. A method as recited in claim 12, wherein said editorial services provided by the publishing system include item manipulation, management, sizing, layout, and printing.

21. A method as recited in claim 12, further comprising the provision of items from the publishing system to the front-end clients in a native format of said front-end clients.

22. A method as recited in claim 12, wherein said envelope for each item is described in SOAP and XML to define and enable handling of the object, and HTTP is used for its transmission; and wherein each said item is characterized by a native format, and the method includes a step to associate additional metadata with each said item to identify the native format of the item; and wherein said items produced by the front-end clients include charts, text, and images; and further comprising a step for providing items from the publishing system to the front-end clients in the native format of said front-end clients.

23. A computer-readable medium comprising executable instructions for instruction a computer to perform the method recited in claim 12.

24. A computer-readable medium comprising instructions for causing a computer to perform a web service for facilitating the interoperability of a publishing system with a plurality of front-end clients, wherein the publishing system includes a repository and a server for providing editorial services with respect to digital items produced by the front-end clients, wherein each digital said item is characterized by a native format, the web service comprising the creation of a metadata envelope associated with each item, thereby providing an object corresponding to each item, each said object being accessible within said publishing system.

25. A computer-readable medium as recited in claim 24, wherein said envelope for each item is sufficient to enable the publishing system to manipulate the item.

26. A computer-readable medium as recited in claim 25, wherein said envelope is described in SOAP and XML to define and enable handling of the object and HTTP is used for its transmission.

27. A computer-readable medium as recited in claim 24, wherein each said item is characterized by a native format, and wherein the system includes a mechanism to associate additional metadata with each said item to identify the native format of the item.

28. A computer-readable medium as recited in claim 24, wherein the system is operable as a web service, generating a format field and providing standardized (HTTP/XML/SOAP) connections between the publishing system and the front-end clients.

29. A computer-readable medium as recited in claim 24, wherein said items produced by the front-end clients include charts, text, and images.

30. A computer-readable medium as recited in claim 24, wherein at least one of said front-end clients comprises a writing and editing program.

31. A computer-readable medium as recited in claim 24, wherein at least one of said front-end clients comprises a page design program.

32. A computer-readable medium as recited in claim 24, wherein said editorial services provided by the publishing system include item manipulation, management, sizing, layout, and printing.

33. A computer-readable medium as recited in claim 24, further comprising software based mechanism for providing items from the publishing system to the front-end clients in a native format of said front-end clients.

34. A computer-readable medium as recited in claim 24, wherein said envelope for each item is described in SOAP and XML to define and enable handling of the object, and HTTP is used for its transmission; and wherein each said item is characterized by a native format, and the system includes a mechanism to associate additional metadata with each said item to identify the native format of the item; and wherein said items produced by the front-end clients include charts, text, and images; and further comprising a software based mechanism for providing items from the publishing system to the front-end clients in the native format of said front-end clients.
